(19) United States
(12) Patent Application Publication
(10) Pub. No.: US 2025/0306630 A1
(43) Pub. Date: Oct. 2, 2025

(54) DETECTING OBJECT GRASPS WITH LOW-POWER CAMERAS AND SENSOR FUSION ON THE WRIST, AND SYSTEMS AND METHODS OF USE THEREOF

(71) Applicant: Meta Platforms Technologies, LLC, Menlo Park, CA (US)

(72) Inventors: Roger Boldu Busquets, Bellevue, WA (US); Eric Whitmire, Kenmore, WA (US); Wolf Kienzle, Seattle, WA (US); Rajinder Sodhi, Seattle, WA (US); Nathan Devrio, Seattle, WA (US)

(21) Appl. No.: 19/094,684

(22) Filed: Mar. 28, 2025

Related U.S. Application Data
(60) Provisional application No. 63/573,118, filed on Apr. 2, 2024.

(51) Int. Cl. G06F 1/16; G02B 27/01; G06V 10/143; G06V 10/82; G06V 40/20; G06V 40/70

(52) U.S. Cl. CPC G06F 1/163; G02B 27/0172; G06V 10/143; G06V 10/82; G06V 40/28; G06V 40/70; G02B 2027/0138; G02B 2027/014; G02B 2027/0178

(57) ABSTRACT

A method of grasp detection is described. The method includes, capturing, via one or more image sensors of a wearable device, image data including a plurality of frames. The plurality of frames includes an object within a field of view of the one or more image sensors. The method further includes capturing, via one or more non-image sensors of the wearable device, sensor data including a sensed interaction with the object and a user of the wearable device and identifying a grasp action performed by the user based on a combination of the sensor data and the image data.

### PRIORITY AND RELATED APPLICATIONS

This application claims priority to U.S. Provisional Patent App. No. 63/573,118, filed Apr. 2, 2024, which is hereby incorporated by reference in its entirety.

### TECHNICAL FIELD

This relates generally to grasp detection, including but not limited to a low-power wrist- worn sensor fusion approach to grasp detection.

### BACKGROUND

Current wearable devices, such as smartwatches, offer a range of health and fitness tracking features; however, these devices lack the capabilities to detect and identify many user actions, which limits their functionality. Additionally, many of these devices lack context awareness to further analyze a user's actions. For example, a smartwatch may infer that a user is cooking based on the user operating a cooking application at a coupled device; however, the smartwatch does not automatically recognize the user's actions or objects they are interacting with. As such, there is a need to address one or more of the above-identified challenges. A brief summary of solutions to the issues noted above are described below.

### SUMMARY

The systems and methods disclosed herein include methods and systems for using sensor fusion to detect that a user is interacting with (e.g., grasping) an object, which can be used to provide additional context as to the user's actions. When a user is interacting with a physical object, the disclosed systems can determine context about the interaction and can take appropriate action, such as providing additional information to the user. For example, if a user is tracking their water intake, the system could be used to track each time the user drinks from their water bottle and/or count how many glasses of water the user consumes. In another example, if a user is interacting with an artificial reality (AR) system, information about the user's actions can be provided to the AR system so that the AR system may respond (e.g., by updating a user interface or providing feedback to the user about the actions).

In accordance with some embodiments, a wearable device (e.g., a wristband or smartwatch) includes one or more non-image sensors (e.g., neuromuscular sensors), one or more image sensors, one or more processors, and memory, comprising instructions, which, when executed by the one or more processors, cause the wearable device to perform one or more operations. The one or more operations include capturing, via the one or more image sensors, image data including a plurality of frames. The plurality of frames includes an object within a field of view of the one or more image sensors. The operations further include capturing, via the one or more non-image sensors, sensor data including a sensed interaction with the object and a user of the wearable device and identifying a grasp action performed by the user based on a combination of the sensor data and the image data.

In accordance with some embodiments, a method of grasp detection includes capturing, via one or more image sensors of a wearable device, image data including a plurality of frames. The plurality of frames includes an object within a field of view of the one or more image sensors. The method further includes capturing, via one or more non-image sensors of the wearable device, sensor data including a sensed interaction with the object and a user of the wearable device and identifying a grasp action performed by the user based on a combination of the sensor data and the image data.

In accordance with some embodiments, an extended-reality headset includes one or more cameras, one or more displays (e.g., placed behind one or more lenses), and one or more programs, where the one or more programs are stored in memory and configured to be executed by one or more processors. The one or more programs include instructions for performing operations. The operations include capturing, via one or more image sensors of the wearable device, image data including a plurality of frames. The plurality of frames includes an object within a field of view of the one or more image sensors. The operations further include capturing, via one or more non-image sensors of the wearable device, sensor data including a sensed interaction with the object and a user of the wearable device and identifying a grasp action performed by the user based on a combination of the sensor data and the image data.

Instructions that cause performance of the methods and operations described herein can be stored on a non-transitory computer-readable storage medium. The non-transitory computer- readable storage medium can be included on a single electronic device or spread across multiple electronic devices of a system (computing system). A non-exhaustive list of electronic devices that can either alone or in combination (e.g., a system) perform the method and operations described herein includes an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience includes an extended- reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, an intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1F illustrate an example user scenario involving the wrist-wearable device detecting the user interacting with a glass of water, in accordance with some embodiments.

FIG. 2 illustrates one example of the operations of the grasp prediction model, in accordance with some embodiments.

FIG. 3 shows an example method flow chart for grasp detection, in accordance with some embodiments.

FIGS. 4A, 4B, 4C-1, and 4C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device); in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, and other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in the memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Example Grasp Detection Techniques

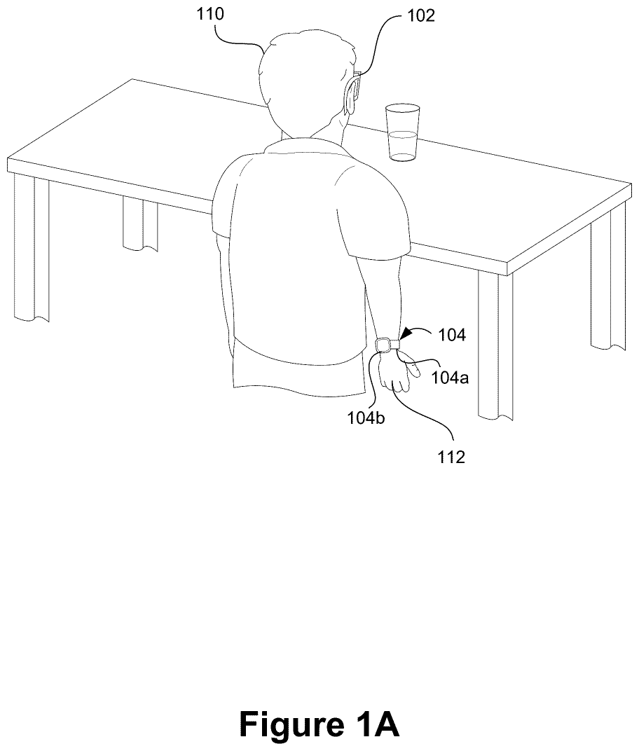

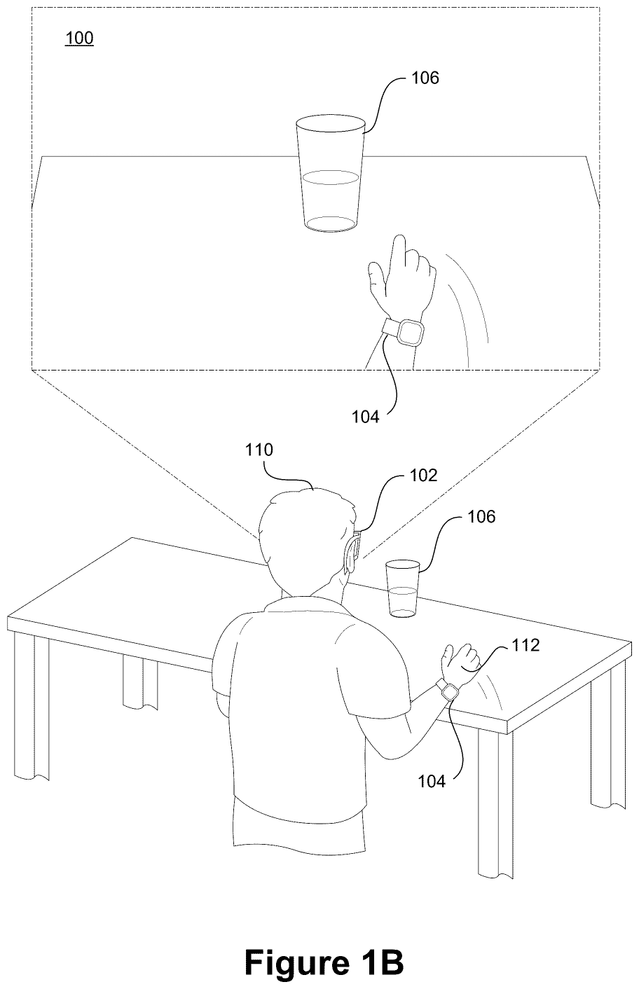

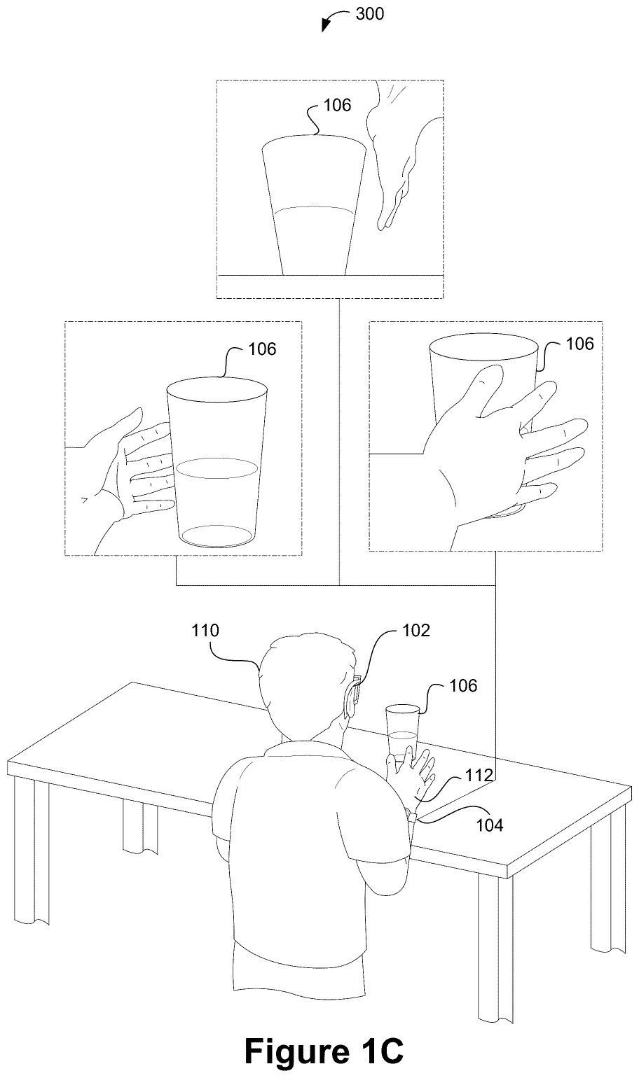

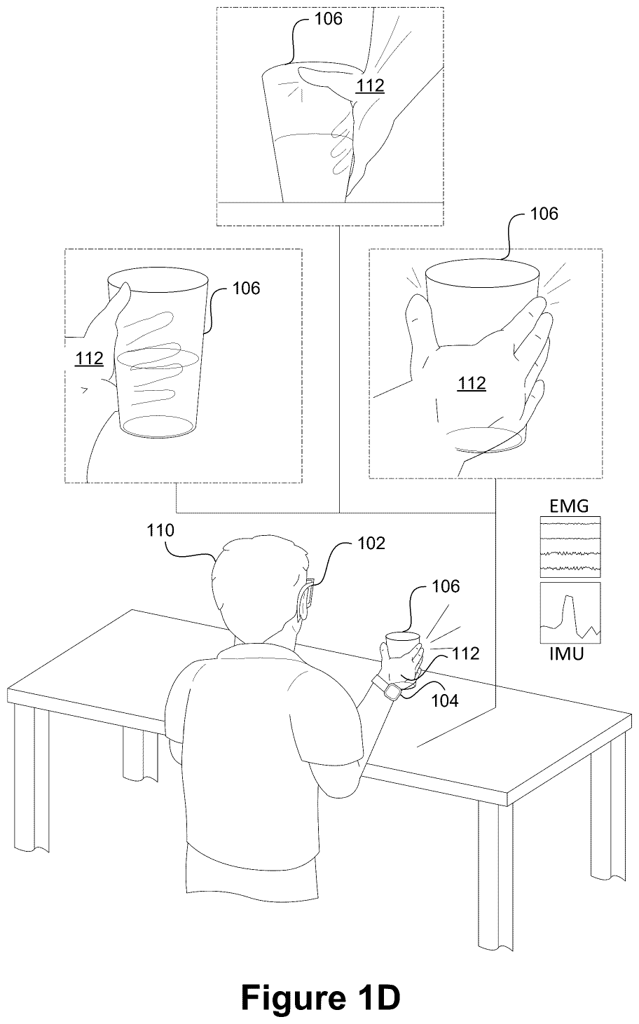

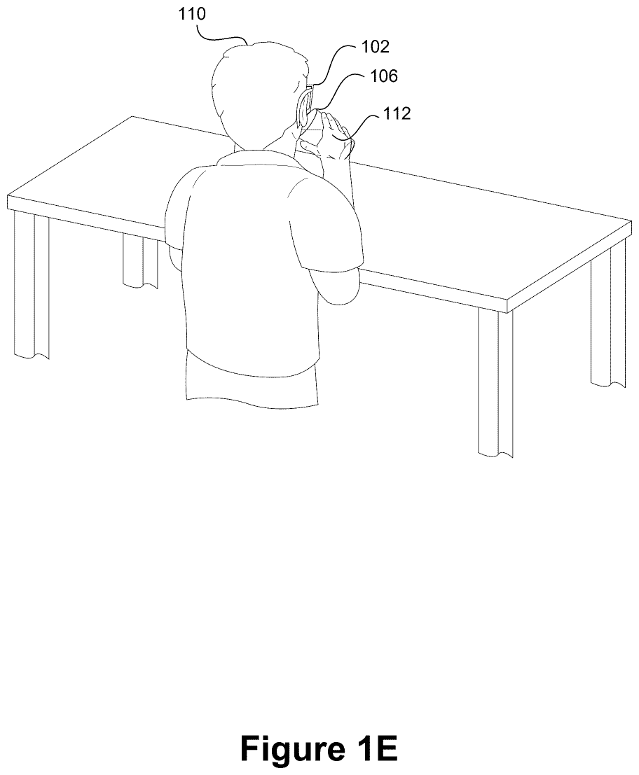

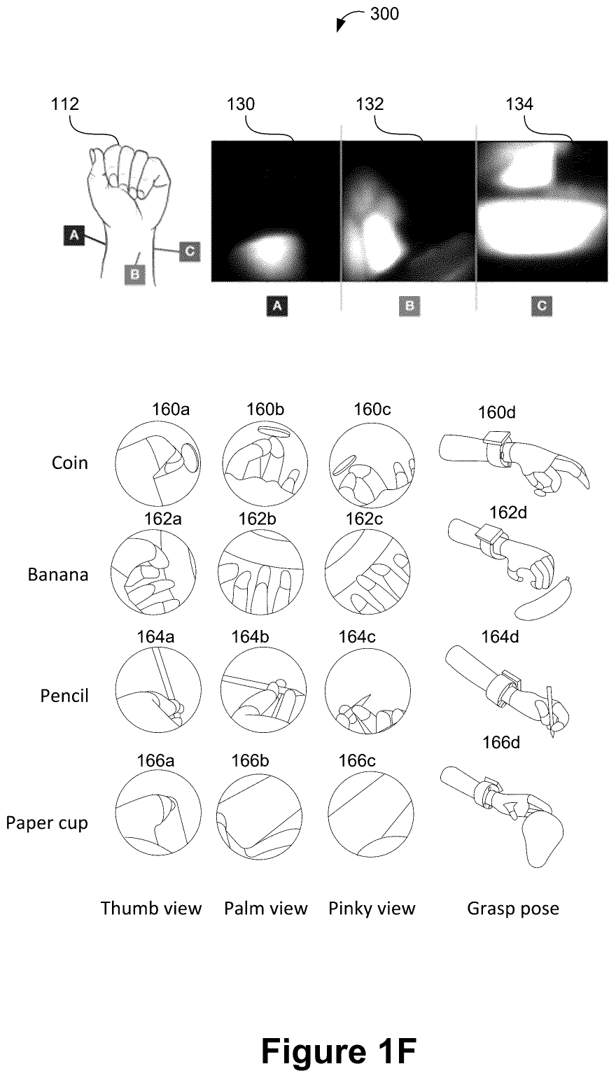

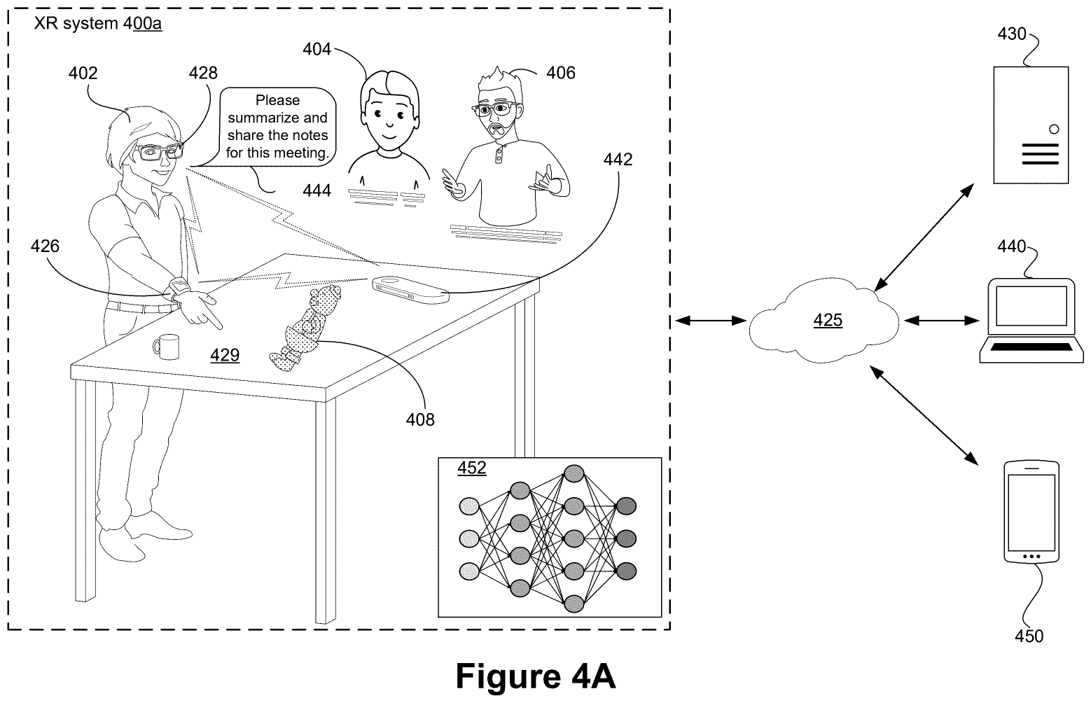

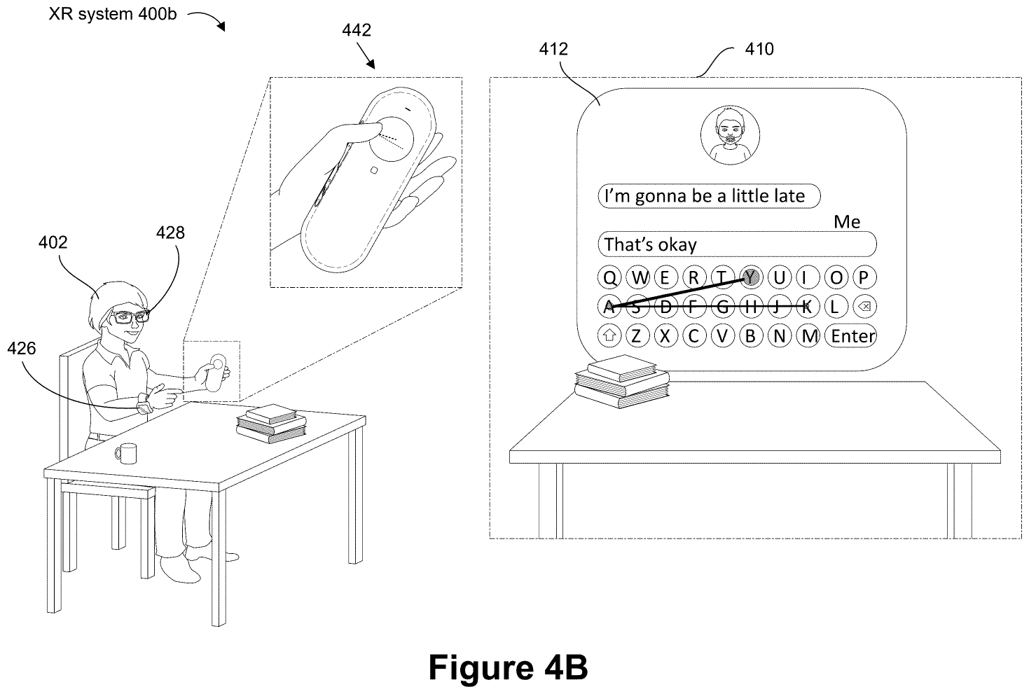

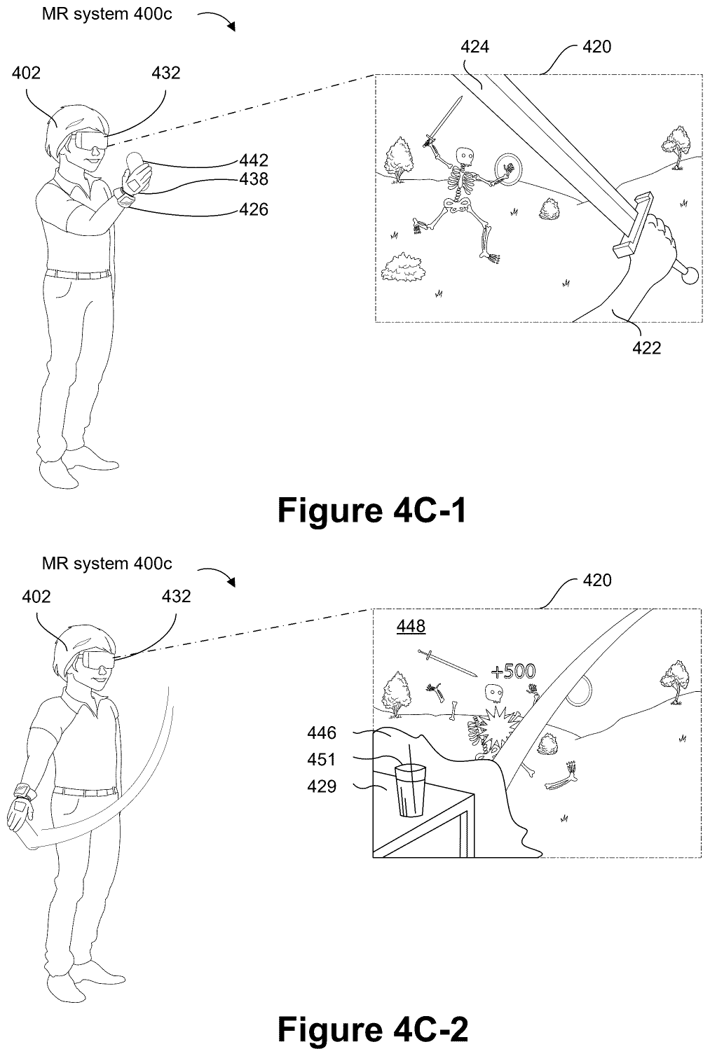

FIGS. 1A-1F illustrate an example user scenario involving a wrist-wearable device 104 detecting a user 110 interacting with a glass of water, in accordance with some embodiments. The user 110 in FIG. 1A is wearing a head-wearable device 102 (e.g., an extended-reality headset, AR glasses, smart glasses, etc.) and a wrist-wearable device 104 (e.g., a smartwatch or other type of wristband). In some embodiments, the head-wearable device 102 is an instance of AR device 428 in FIG. 4A and the wrist-wearable device 104 is an instance of wrist-wearable device 426 in FIG. 4A. In some embodiments, the head-wearable device 102 is a mixed-reality device with a passthrough feature that allows the user 110 to see their hands and arms if they are within the field of view. The user 110 in FIG. 1A is viewing a scene that includes a table and a glass of water.

In some embodiments, the wrist-wearable device 104 includes one or more image sensors (e.g., cameras) coupled to a band portion 104a and/or a capsule portion 104b of the wrist-wearable device 104. The image sensors are configured to capture image data and may include a low-resolution optical camera; an infrared (IR) camera; a red, green, and blue (RGB) camera; a near-infrared camera; and/or a monochrome camera. Each respective image sensor may include an LED (e.g., an IR LED or other type of light source) that can be used for active illumination of the target. In some embodiments, the image data includes image data corresponding to one or more of a hand of the user physically interacting with an object and the hand of the user near the object. For example, the image data may include an image frame showing the user's hand within grasping range of the object as illustrated in FIG. 1C, and an image frame showing the user's hand grasping the object as illustrated in FIG. 1D. In some embodiments, the image sensors are configured to have low resolution (e.g., less than 120×120 resolution, less than 100×100 resolution, or less than 50×50 resolution), e.g., to protect the privacy of the user 110 and others around them. In some embodiments, the resolution of the frames captured by the image sensors are less than 70 pixels×70 pixels (e.g., 30 pixels×30 pixels), which is sufficient to identify user interactions without capturing additional details that may reduce the privacy of the user and others. In some embodiments, the wrist-wearable device 104 includes multiple image sensors, e.g., three cameras placed on the palmar side of the wrist-wearable device 104, near the thumb of the user 110, and near the pinky of the user 110. The placement of the one or more image sensors is configured to provide the capture angles (e.g., fields of view) to capture the movement of the user's hand 112 and provide context to the system.

In some embodiments, the wrist-wearable device 104 includes one or more non-image sensors such as an inertial measurement unit (IMU), an accelerometer, neuromuscular signal sensors (EMG), and the like. The non-image sensors may be configured to detect movement by the user 110 and provide data to the one or more processors, e.g., for use with determining if the user 110 is about to or has grasped an object. In some embodiments, the non-image sensors are coupled to, or integrated into, the wrist-wearable device 104. Each non-image sensor may be configured to detect a different type of movement. For example, an accelerometer can detect the initial movement of the arm and vibrations when the user 110 makes contact with an object. The EMG sensors can detect extension and flexion of the fingers when opening and closing the user's hand 112 (e.g., during grasping actions).

Turning to FIG. 1B, the user 110 is moving their hand 112 and arm and reaching for the glass of water 106. FIG. 1B also illustrates the user 110 viewing a scene 100 via a display of the head-wearable device 102. In this example, the wrist-wearable device 104 detects the movement of the user's arm and hand 112, and, in response to the movement, may activate the image sensors integrated with, or coupled to, the wrist-wearable device. In this way, the image sensors may be powered down (or operated with reduced power) in the absence of movement, which extends the battery life of the wrist-wearable device 104. In some embodiments, the movements of the user 110 are detected at the wrist-wearable device 104 via an IMU and/or accelerometer. In some embodiments, the image sensors are activated prior to the user 110 moving their hand 112. In some embodiments, when the movement of the user's arm is detected (e.g., in response to the movement), one or more image sensors of the head-wearable device 102 are activated to provide additional image data for the system (e.g., used to determine a context for the movement). For example, the image sensors at the head-wearable device 102 may capture one or more images that depict the glass of water 106 and the user's hand 112. Additionally, when the sensors coupled to the wrist-wearable device 104 determines that it does not have sufficient context information, it may provide a trigger to other devices, such as the head-wearable device 102, to capture additional information and/or perform contextual analysis.

FIG. 1C illustrates the user 110 opening their hand 112 just prior to grasping the glass of water 106. As the user 110 opens their hand 112, the wrist-wearable device 104 may detect the flexions of the user's hand 112 and fingers using one or more neuromuscular sensors (e.g., EMG sensors). The neuromuscular sensors may be configured to detect the extension and flexion of the fingers (e.g., based on signals sent via muscle groups of the user's arm). In some embodiments, one or more image sensors are activated and configured to capture image data that includes images of the user's hand 112 and the glass of water 106. In some embodiments, the one or more image sensors are activated prior to the user opening their hand 112.

In some embodiments, capturing image data of a target (e.g., the user's hand 112 and the glass of water 106) includes capturing a sequence of three frames while toggling an IR light source (e.g., an IR LED) coupled to the imaging sensors from an OFF state to an ON state and then back to an OFF state. Once the sequence is complete, the two IR-OFF frames may be averaged and subtracted from the IR-ON frame to produce, e.g., after additional post processing, a single low-resolution frame (e.g., 30×30 frame). In this frame, only the objects illuminated by the IR light source are visible (e.g., those close to the imaging sensor(s)), while other background is removed. An example output frame is illustrated in FIG. 1F. This approach may be used to emphasize the prominent features in the output images that are salient to the grasp detection problem, such as the user's hand 112 and objects near the user's hand 112 (e.g., the glass of water 106). This IR-based approach can make the downstream recognition task easier by obviating the need to perform separate object segmentation on the image data frames to find the user's hand 112 and objects. In addition, removing the background can improve privacy and security for the user and others within the detection range.

FIG. 1D illustrates the user 110 grasping the glass of water 106. In some embodiments, contact with the glass of water is determined using an accelerometer based on the vibrations of the user's hand 112 interacting with the glass of water 106. In some embodiments, the grasp is detected via neuromuscular sensors. As discussed below, in some embodiments, multiple sensors may be used to detect the user's grasp, e.g., because different sensors may be better positioned/configured to detect different types of interactions as is discussed in more detail in FIG. 1E.

FIG. 1E illustrates the wrist-wearable device 104 detecting the user 110 lifting the glass of water 106. In some embodiments, the detection is performed using neuromuscular sensors, e.g., measuring the strain on the user's hand or wrist. The neuromuscular sensors may be configured to measure the strain put on the user's muscles and can more accurately determine if the user 110 is picking up an object (e.g., as opposed to grasping a virtual object or making a grasping gesture that doesn't involve an object).

As another example, neuromuscular sensor(s) may be used to detect muscle strain during a lift action. For example, an arm lift movement can be sensed using an IMU, and the neuromuscular sensor(s) may be used to determine whether the lift movement comprises lifting a real-world object. In some embodiments, an IMU sensor is used to detect lift movements. Neuromuscular sensors may be configured to detect transient change in signal power. For example, when picking up a light object, there is less strain put on the arm muscles so signal power changes less, and thus the change in a neuromuscular signal trace may be difficult to sense and/or distinguish from noise.

FIG. 1F illustrates example hand poses when grasping an assortment of objects. FIG. 1F further illustrates the location of the at least three imaging sensors around the user's wrist that are coupled to, or integrated with, the wrist-wearable device 104 (e.g., in locations A, B, and C). The positions of the image sensors are at the front edge of the watch band facing the user's hand 112 such that the image sensors have the best field of view of the user's hand 112 and possible objects the user 110 will interact with. Furthermore, the position, pitch angle, and tilt angle of each sensor may be determined using 3D models of a grasp pose and an object to determine the best configuration. The positions include (A) beside the user's thumb, (B) in front of the user's palm and ring finger, and (C) beside the user's pinky fever. The images 130-134 illustrate example low-resolution IR images taken by each respective image sensor. For example, the image 130 is representative of an image captured by the image sensor beside the user's thumb (A), the image 132 is representative of an image captured in front of the user's palm and ring finger (B), and the image 134 is representative of an image captured beside the user's pinky finger (C).

FIG. 1F further illustrates a rendering of what a grasp pose may look like for each image sensor of four test objects (e.g., a coin, a banana, a pencil, and a paper cup). In some embodiments, a grasp model is trained on one or more of these grasp poses, e.g., to further include context for what the user 110 is interacting with. For example, the system may obtain image data including image frames 160a-160c and determine that the user 110 is grasping a coin. The image frames 160a-160c illustrate image frames taken from multiple image sensors while the user 110 is grasping the object (e.g., the coin). For example, image frame 160a illustrates the user 110 grasping the coin from the image sensor viewing the thumb (e.g., image sensor in position A), image frame 160b illustrates the user 110 grasping the coin from the image sensor viewing the palm (e.g., image sensor in position B), image frame 160c illustrates the user 110 grasping the coin from the image sensor viewing the pinky (e.g., image sensor in position C), and image frame 160d illustrates a perspective view of the user 110 grasping the coin (e.g., obtained from a head-wearable device).

In another example, the system obtains image data including image frames 162a-162c and determines that the user 110 is grasping a banana. Image frames 162a-162c illustrate image frames taken from multiple image sensors while the user 110 is grasping an object (e.g., the banana). Image frame 162a illustrates the user 110 grasping the banana from the image sensor viewing the thumb (e.g., image sensor in position A), image frame 162b illustrates the user 110 grasping the banana from the image sensor viewing the palm (e.g., image sensor in position B), image frame 162c illustrates the user 110 grasping the banana from the image sensor viewing the pinky (e.g., image sensor in position C), and image frame 162d illustrates a perspective view of the user 110 grasping the banana.

In another example, the system obtains image data including image frames 164a-164c and determines that the user 110 is grasping a pencil. Image frames 164a-164c illustrate image frames taken from multiple image sensors while the user 110 is grasping an object (e.g., the pencil). Image frame 164a illustrates the user 110 grasping the pencil from the image sensor viewing the thumb (e.g., image sensor in position A), image frame 164b illustrates the user 110 grasping the pencil from the image sensor viewing the palm (e.g., image sensor in position B), image frame 164c illustrates the user 110 grasping the pencil from the image sensor viewing the pinky (e.g., image sensor in position C) and image frame 164d illustrates a perspective view of the user 110 grasping the pencil.

In another example, the system obtains image data including image frames 166a-166c and determines that the user 110 is grasping a paper cup. Image frames 166a-166c illustrate image frames taken from multiple image sensors while the user 110 is grasping an object (e.g., the paper cup). Image frame 166a illustrates the user 110 grasping the paper cup from the image sensor viewing the thumb (e.g., image sensor in position A), image frame 166b illustrates the user 110 grasping the paper cup from the image sensor viewing the palm (e.g., image sensor in position B)., image frame 166c illustrates the user 110 grasping the paper cup from the image sensor viewing the pinky (e.g., image sensor in position C), and image frame 166d illustrates a perspective view of the user 110 grasping the paper cup.

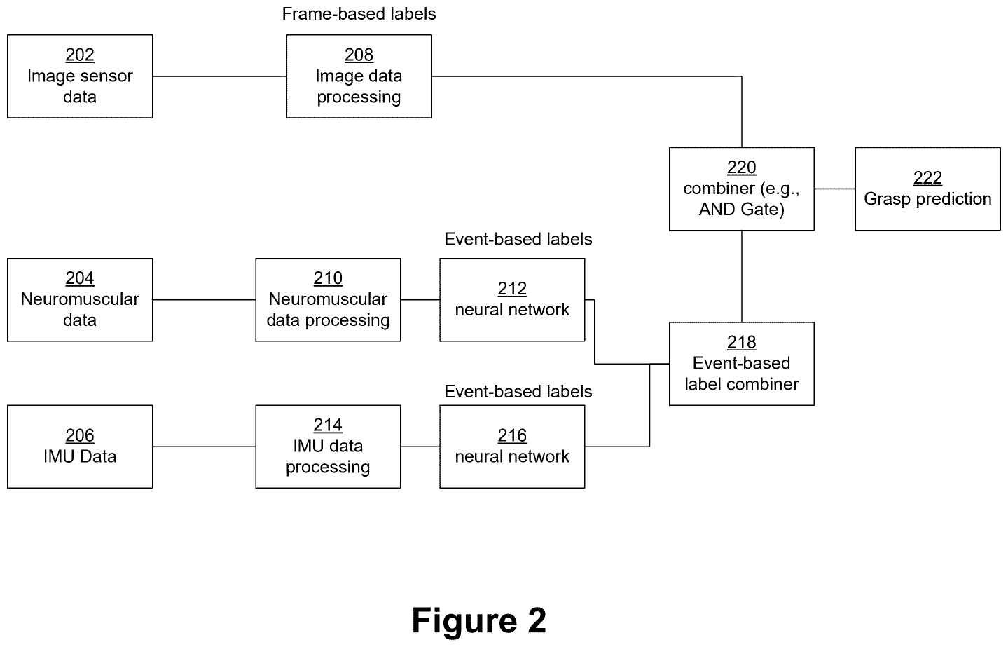

FIG. 2 illustrates an example of the operations of a grasp prediction model, in accordance with some embodiments. In some embodiments, the grasp prediction model receives the sensor data from one or more image sensors and the non-image sensors to determine if a grasp event has occurred and what type of event has occurred. When receiving data from multiple different sources/streams each with a different data rate, and different frame timing, a buffered window approach may be used to address the differences in the data. In a buffered window approach, the data from all sources may be buffered for a set amount of time (e.g., 0.1 seconds, 0.4 seconds, 1 second, 2 seconds or another amount of time). In some embodiments, a timer is called to empty the buffer(s) and interpolate the data into expected frames per second (FPS) of each stream to account for possible dropped or extra frames. This approach may be applied to each respective type of data during their respective data processing.

In some embodiments, a grasp prediction model splits into two branches based on a ground truth label structure. The image sensor data 202 and non-image data (e.g., the IMU data 206 and neuromuscular data 204) capture different aspects of a grasp gesture. For example, image sensor data 202 may be used to determine whether a user 110 is currently holding an object in their hand 112. A label may be assigned to each image frame to indicate if a grasp action has been identified and/or performed. The non-image data may be included in time-series data to determine whether a grasp has occurred, for which an event-based label may be assigned for a particular time. For the image sensor data 202, frame-based labels that indicate when touch states are detected may be applied to each respective image frame of the image data. For the non-image data, event-based labels may be used to indicate when grasp events (e.g., an object picked up or set down) are detected.

During image data processing 208, a predetermined number of FPS (e.g., 75 FPS) may be expected. If more or less (e.g., 74 or 76 FPS) are received instead, the image sensor data 202 may be interpolated in time to get the predetermined FPS (e.g., 75 FPS). The effect of processing on the final data may be negligible as the sections are collected, rearranged, and overlapped to produce fixed-sized, windowed inputs for a model. For example, a 400 ms window with 20% overlap may be used. In some embodiments, the image sensor data 202 is normalized and/or background subtraction is performed on the image sensor data. In some embodiments, the image data processing 208 includes processing the image sensor data 202 using a neural network-based model (e.g., a 3D-CNN model). A 3D-CNN model may be used as it can capture temporal changes in image data and can train more with more stability than other types of models (e.g., LSTM model).

During neuromuscular data processing 210, full-wave rectification and/or a bandpass filter with a predetermined cutoff frequency (e.g., 20 Hz and 800 Hz) may be applied to the neuromuscular data 204. The filtering can remove baseline noise and motion artifacts while rectification improves interpretability of the signals. The neuromuscular data 204 may be further processed using a neural network-based model (e.g., a 1D-CNN model) 212 to capture transient temporal changes in the signal traces.

For IMU data processing 214 (e.g., processing accelerometer data), a similar approach may be used as when processing the neuromuscular data 204. A unit vector may be called to a predetermined amount (e.g., 9.81), rotated using quaternion data from the IMU, and subtracted from the accelerometer vector, e.g., to remove the gravity component. Each window of data may be reviewed, and the minimum of each window may be subtracted from the entire window with the result subsequently being squared. This transformation emphasizes transient spikes in the data which is an accelerometer feature used for grasp detection. The IMU data 206 may be further processed using a neural network-based model (e.g., a 1D-CNN model) 216 to capture transient temporal changes in the signal traces.

In some embodiments, after the neuromuscular data 204 and IMU data 206 are respectively processed, they are combined using a middle-fusion approach and processed through a heuristic trigger function to convert the output to match the frame-based (image) labels. Once in a common format, the outputs of the event-based label branch and the frame-based label branch may be combined and returned with frame-based labels.

In some embodiments, an event-based label combiner 218 fuses the outputs of the model 212 and the model 216 before fully connecting the layers of the neuromuscular data 204 and the IMU data 206. The output from the model 212 and the model 216 may be combined using a middle-fusion or late-fusion approach. In addition, the event-based label combiner 218 further includes applying a heuristic to the combined data (e.g., to smooth the output of the event-based label model and/or determine whether the output state changed in a five-window period including the current window, two in the past, and two in the future). This results in a two-window latency in the final output. If such a state change does occur, combiner 220 may be toggled to sum the output of both models and provide a prediction based on a grasp event label. If the combiner is not triggered, no grasp events are predicted.

In some embodiments, the grasp predictor 222 determines (i) if a grasp event has occurred, and (ii) if so, what type of grasp event occurred. For example, as illustrated in FIGS. 1D and 1E, the grasp predictor 222 may determine that the user 110 grasps a cup of water. In another example, the grasp predictor 222 determines that the user 110 is pinching something, leaning against something, etc. In some embodiments, the grasp predictor 222 determines whether the grasp action is classified as one of a pinch, a palmar, or a cylindrical grasp. For the system determining context based on the grasp, knowing the type of grasp is useful to making a determination of what the user 110 is interacting with. The grasp predictor 222 makes the determination based on the processed data in a grasp prediction model.

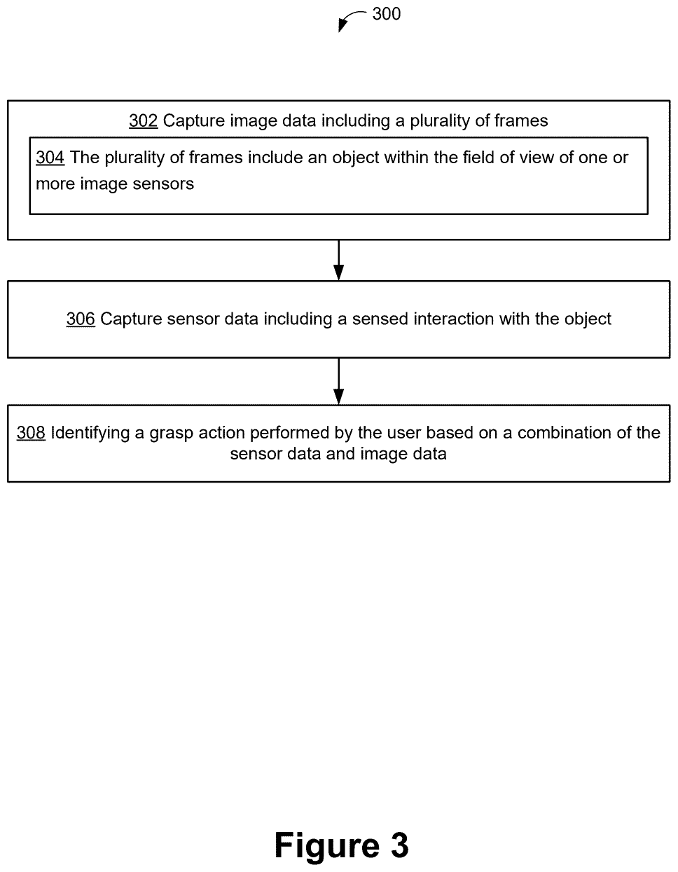

FIG. 3 illustrates a flow diagram of a method of grasp detection, in accordance with some embodiments. Operations (e.g., steps) of the method 300 can be performed by one or more processors (e.g., central processing unit and/or MCU) of a wrist-wearable device 104. At least some of the operations shown in FIG. 3 correspond to instructions stored in a computer memory or computer-readable storage medium (e.g., storage, RAM, and/or memory) integrated into the wrist-wearable device 104. Operations of the method 300 can be performed by a single device alone or in conjunction with one or more processors and/or hardware components of another communicatively coupled device (e.g., head-wearable device 102) and/or instructions stored in memory or computer-readable medium of the other device communicatively coupled to the wrist-wearable device 104. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device, but should not be construed as limiting the performance of the operation to the particular device in all embodiments.

(A1) FIG. 3 shows a flow diagram of a method 300 of grasp detection, in accordance with some embodiments. The method 300 occurs at a wearable device (e.g., wrist-wearable device 104) with one or more image sensors and non-image sensors. In some embodiments, the method 300 includes capturing (302), via one or more image sensors of the wearable device (e.g., wrist-wearable device 104), image data including a plurality of frames. The plurality (304) of frames includes an object (e.g., a glass of water 106) within a field of view of the one or more image sensors (e.g., cameras).

The method 300 further includes capturing (306), via one or more non-image sensors (e.g., EMG and IMU sensors) of the wearable device, sensor data including a sensed interaction with the object (e.g., glass of water 106) and a user of the wearable device.

The method 300 further includes identifying (308), a grasp action performed by the user based on a combination of the sensor data and the image data. As described in FIG. 2, the grasp detection model can determine the type of grasp action performed by the user 110 such as a palmar grasp or a pinch grasp.

(B1) In accordance with some embodiments, a wearable device includes one or more non-image sensors, one or more image sensors, one or more processors, and memory, comprising instructions, which, when executed by the one or more processors, cause the wearable device to perform one or more operations. The one or more operations include capturing, via the one or more image sensors, image data including a plurality of frames. The plurality of frames includes an object within a field of view of the one or more image sensors. The operations further include capturing, via the one or more non-image sensors, sensor data including a sensed interaction with the object and a user of the wearable device and identifying a grasp action performed by the user based on a combination of the sensor data and the image data. In some embodiments, the one or more image sensors comprise one or more of a low-resolution optical camera, an RGB camera, an infrared camera, a near-infrared camera, and a monochrome camera. In some embodiments, the image data comprises image data corresponding to one or more of a hand of the user physically interacting with an object, and the hand of the user near the object. For example, the image data may include an image frame showing the user's hand within grasping range of the object.

(B2) In some embodiments of B1, identifying the grasp action comprises determining an image-based grasp label by applying a frame-based model to the image data (e.g., as described previously with respect to FIG. 2).

(B3) In some embodiments of B2, identifying the grasp action comprises determining a sensor-based grasp label by applying an event-based model to the sensor data (e.g., as described previously with respect to FIG. 2).

(B4) In some embodiments of B3, identifying the grasp action comprises formatting the sensor-based grasp label to a formatted sensor-based grasp label, where the formatted sensor-based grasp label has a same format as the image-based grasp label.

(B5) In some embodiments of B4, formatting the sensor-based grasp label comprises at least one of (i) applying a band pass filter (e.g., with cutoff frequencies of 10 Hz and 800 Hz) to the sensor-based grasp label and (ii) performing a full-wave rectification. For example, filtering (e.g., for EMG, accelerometer, and/or IMU data) may remove baseline noise and/or motion artifacts while rectification improves interpretability of the signals.

(B6) In some embodiments of B4 or B5, identifying the grasp action comprises determining, using a grasp detection model, that the grasp action has occurred based on a combination of the image-based grasp label and the formatted sensor-based grasp label.

(B7) In some embodiments of any of B1-B6, the memory further comprises instructions to perform operations for classifying the grasp action.

(B8) In some embodiments of B7, the grasp action is classified as one of a pinch, a palmar, or a cylindrical grasp.

(B9) In some embodiments of any of B1-B7, the memory further comprises instructions to, in accordance with identifying the grasp action, generate a signal configured to activate another device to perform an additional grasp event determination. For example, the wearable device may generate a signal to notify a head-wearable device (e.g., an AR device) about the grasp action.

(B10) In some embodiments of any of B1-B9, the memory further comprises instructions to, prior to identifying the grasp action, generate a combined frame by combining multiple frames of the plurality of frames, where the grasp action is based on analysis of the combined frame. For example, a set of frames from the plurality of frames may be averaged together to generate the combined frame.

(B11) In some embodiments of B10, capturing the image data comprises (i) capturing a first frame while an infrared (IR) emitter is inactive and (ii) after capturing the first frame, capturing a second frame while the IR emitter is active. After capturing the second frame, capturing a third frame while the IR emitter is inactive and the combined frame is generated from the first frame, the second frame, and the third frame.

(B12) In some embodiments of any of B11, generating the combined frame comprises (i) generating a fourth frame by averaging the first frame and the third frame and (ii) generating the combined frame by subtracting the fourth frame from the second frame.

(B13) In some embodiments of any of B10, the combined frame has a resolution of 30 pixels by 30 pixels or less. As described previously with respect to FIG. 1A, in some embodiments, the combined frame has a resolution of 60 pixels by 60 pixels or less.

(B14) In some embodiments of any of B1-B13, the wearable device comprises a wrist-wearable device (e.g., wrist-wearable device 104). In some embodiments, the wearable device is an arm-worn device (e.g., attachable to a forearm of the user). In some embodiments, the wearable device is a hand-worn device (e.g., a glove).

(B15) In some embodiments of B14, the one or more image sensors are coupled to at least one of a capsule portion of the wrist-wearable device (e.g., capsule portion 104b of the wrist-wearable device 104), and a band portion of the wrist-wearable device (e.g., band portion 104a of the wrist-wearable device 104). For example, as described previously with respect to FIG. 1F, an image sensor may be positioned on a palmar side of the wrist. In some embodiments, the one or more sensors comprise an image sensor on a palmar side of the wrist and one or more additional image sensors (e.g., at a thumb side of the wrist, at a pinky side of the wrist, and/or a dorsal side of the wrist).

(B16) In some embodiments of B15, the one or more image sensors comprise one or more of (i) a first image sensor coupled to a first portion of the band portion such that the first image sensor is adjacent to a thumb of the user while the wearable device is being worn by the user, (ii) a second image sensor coupled to a second portion of the band portion such that the second image sensor is adjacent to a palm of the user while the wearable device is being worn by the user, and (iii) a third image sensor coupled to a third portion of the band portion such that the third image sensor is adjacent to a pinky finger of the user while the wearable device is being worn by the user. FIG. 1F further illustrates and describes the one or more image sensors and their fields of view of the user's hand 112 and possible graspable objects. In some embodiments, the one or more image sensors are arranged such that each image sensor has a distinct field of view (FOV). In some embodiments, the respective FOVs are overlapping. In some embodiments, the respective FOVs are non-overlapping.

(B17) In some embodiments of any of B1-B16, the one or more non-image sensors comprise neuromuscular sensors. For example, the neuromuscular sensors may be EMG sensors. In some embodiments, the non-image sensors comprise an electromyography (EMG) sensor, an accelerometer, and/or an inertial measurement unit (IMU).

(B18) In some embodiments of any of B1-B17, the sensor data comprises data corresponding to at least one of a movement of an arm of the user, vibration of an appendage of the user (e.g., from contacting the object), and flexions of muscles of the user (e.g., muscles coupled with the user's wrist or the user's hand 112). In some embodiments, the data corresponds to extensions of the muscles of the user. As an example, an accelerometer may be used to detect arm movement from a user and/or detecting vibrations in the user's arm. As another example, neuromuscular sensors may be used to detect muscle strain during an object lift, extensions and flexion of the wrist and fingers, and/or the user's hand tightening their grip on the object and picking it up to complete the grasp. As another example, an IMU may be used to detect arm movements (e.g., arm lift movements).

(C1) In accordance with some embodiments, a non-transitory computer-readable storage medium including instructions that, when executed by a computing device in communication with a pair of augmented-reality glasses, cause the computer device to perform one or more operations. The operations include capturing, via one or more image sensors of the wearable device, image data including a plurality of frames. The plurality of frames includes an object within a field of view of the one or more image sensors. The operations further include capturing, via one or more non-image sensors of the wearable device, sensor data including a sensed interaction with the object and a user of the wearable device and identifying a grasp action performed by the user based on a combination of the sensor data and the image data.

### Example Extended-Reality Systems

FIGS. 4A, 4B, 4C-1, and 4C-2, illustrate example XR systems that include AR and MR systems, in accordance with some embodiments. FIG. 4A shows a first XR system 400a and first example user interactions using a wrist-wearable device 426, a head-wearable device (e.g., AR device 428), and/or a HIPD 442. FIG. 4B shows a second XR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., an MR device such as a VR device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near field, Wi-Fi, personal area network, wireless LAN). Additionally, the wrist-wearable device 426, the head-wearable device, and/or the HIPD 442 can also communicatively couple with one or more servers 430, computers 440 (e.g., laptops, computers), mobile devices 450 (e.g., smartphones, tablets), and/or other electronic devices via the network 425 (e.g., cellular, near field, Wi-Fi, personal area network, wireless LAN). Similarly, a smart textile-based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428 and having the HIPD 442 on their desk. The wrist-wearable device 426, the AR device 428, and the HIPD 442 facilitate user interaction with an AR environment. In particular, as shown by the first AR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table 429, through transparent lens(es) and waveguide(s) of the AR device 428. Alternatively, an MR device could be used in place of the AR device 428 and a similar user experience can take place, but the user would not be directly viewing physical objects in the environment, such as table 429, and would instead be presented with a virtual reconstruction of the table 429 produced from one or more sensors of the MR device (e.g., an outward facing camera capable of recording the surrounding environment).

The user 402 can use any of the wrist-wearable device 426, the AR device 428 (e.g., through physical inputs at the AR device and/or built-in motion tracking of a user's extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent digital assistant to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402′s eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first AR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first AR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, an MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact and/or manipulate the virtual object 408. While an AR device 428 is described working with a wrist-wearable device 426, an MR headset can be interacted with in the same way as the AR device 428.

### Integration of Artificial Intelligence With XR Systems

FIG. 4A illustrates an interaction in which an artificially intelligent virtual assistant can assist in requests made by a user 402. The AI virtual assistant can be used to complete open-ended requests made through natural language inputs by a user 402. For example, in FIG. 4A the user 402 makes an audible request 444 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 4A also illustrates an example neural network 452 used in Artificial Intelligence applications. Uses of Artificial Intelligence (AI) are varied and encompass many different aspects of the devices and systems described herein. AI capabilities cover a diverse range of applications and deepen interactions between the user 402 and user devices (e.g., the AR device 428, an MR device 432, the HIPD 442, the wrist-wearable device 426). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 402 can interact with an AI model through natural language inputs captured by a voice sensor, text inputs, or any other input modality that accepts natural language and/or a corresponding voice sensor module. In another instance, input is provided by tracking the eye gaze of a user 402 via a gaze tracker module. Additionally, the AI model can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 428) or from multiple devices that are in communication with each other (e.g., a system that includes at least two of an AR device 428, an MR device 432, the HIPD 442, the wrist-wearable device 426, etc.). The AI model can also access additional information (e.g., one or more servers 430, the computers 440, the mobile devices 450, and/or other electronic devices) via a network 425.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud- computing platforms communicatively coupled to the user devices (e.g., the AR device 428, an MR device 432, the HIPD 442, the wrist-wearable device 426) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, an MR device 432, the HIPD 442, the wrist-wearable device 426), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 442), haptic feedback can provide information to the user 402. An AI model can also use the inputs described above to determine the appropriate modality and device(s) to present content to the user (e.g., a user walking on a busy road can be presented with an audio output instead of a visual output to avoid distracting the user 402).

### Example Augmented Reality Interaction

FIG. 4B shows the user 402 wearing the wrist-wearable device 426 and the AR device 428 and holding the HIPD 442. In the second AR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second AR system 400b the user 402 performs a hand gesture associated with a command for initiating a messaging application (represented by messaging user interface 412); the wrist-wearable device 426 detects the hand gesture; and, based on a determination that the user 402 is wearing the AR device 428, causes the AR device 428 to present a messaging user interface 412 of the messaging application. The AR device 428 can present the messaging user interface 412 to the user 402 via its display (e.g., as shown by user 402's field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402's gestures performed on the HIPD 442 can be provided and/or displayed on another device. For example, the user 402's swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 428 can present to the user 402 game application data and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters) and capture image data.

While an AR device 428 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 4C-1 and 4C-2, the user 402 is shown wearing the wrist-wearable device 426 and an MR device 432 (e.g., a device capable of providing either an entirely VR experience or an MR experience that displays object(s) from a physical environment at a display of the device) and holding the HIPD 442. In the third AR system 400c, the wrist-wearable device 426, the MR device 432, and/or the HIPD 442 are used to interact within an MR environment, such as a VR game or other MR/VR application. While the MR device 432 presents a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402's motion. For example, image sensors (e.g., SLAM cameras or other cameras) of the HIPD 442 can be used to detect a position of the HIPD 442 relative to the user 402's body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402's movements; and image sensors of the MR device 432 can be used to represent the user 402's body, boundary conditions, or real-world objects within the first MR game environment 420.

In FIG. 4C-2, the user 402 performs a downward swing while holding the HIPD 442. The user 402's downward swing is detected by the wrist-wearable device 426, the MR device 432, and/or the HIPD 442 and a corresponding action is performed in the first MR game environment 420. In some embodiments, the data captured by each device is used to improve the user's experience within the MR environment. For example, sensor data of the wrist-wearable device 426 can be used to determine a speed and/or force at which the downward swing is performed and image sensors of the HIPD 442 and/or the MR device 432 can be used to determine a location of the swing and how it should be represented in the first MR game environment 420, which, in turn, can be used as inputs for the MR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment are likely). Thus, this example MR game environment 420 includes (i) an immersive VR portion 448 (e.g., an environment that does not have a corollary counterpart in a nearby physical environment) and (ii) a reconstruction of the physical environment 446 (e.g., table 429 and cup 451). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the user 402's movements (while holding the HIPD 442) to cause the performance of corresponding actions within the first MR game environment 420. Additionally or alternatively, in some embodiments, operational data (e.g., sensor data, image data, application data, device data, and/or other data) of one or more devices is provided to a single device (e.g., the HIPD 442) to process the operational data and cause respective devices to perform an action associated with processed operational data.

In some embodiments, the user 402 can wear a wrist-wearable device 426, wear an MR device 432, wear smart textile-based garments 438 (e.g., wearable haptic gloves), and/or hold an HIPD 442 device. In this embodiment, the wrist-wearable device 426, the MR device 432, and/or the smart textile-based garments 438 are used to interact within an MR environment (e.g., any AR or MR system described above in reference to FIGS. 4A-4B). While the MR device 432 presents a representation of an MR game (e.g., second MR game environment 420) to the user 402, the wrist-wearable device 426, the MR device 432, and/or the smart textile-based garments 438 detect and coordinate one or more user inputs to allow the user 402 to interact with the MR environment.

In some embodiments, the user 402 can provide a user input via the wrist-wearable device 426, an HIPD 442, the MR device 432, and/or the smart textile-based garments 438 that causes an action in a corresponding MR environment. In some embodiments, each device uses respective sensor data and/or image data to detect the user input and provide an accurate representation of the user 402's motion. While four different input devices are shown (e.g., a wrist-wearable device 426, an MR device 432, an HIPD 442, and a smart textile-based garment 438) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 438) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 438 can be used in conjunction with an MR device and/or an HIPD 442.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic

The foregoing descriptions of FIGS. 4A-4C-2 provided above are intended to augment the description provided in reference to FIGS. 1A-1F, 2, and 3. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A wearable device, comprising:
one or more non-image sensors;
one or more image sensors;
one or more processors; and
memory, comprising instructions, which, when executed by the one or more processors, cause the wearable device to perform operations for:
capturing, via the one or more image sensors, image data including a plurality of frames, wherein the plurality of frames includes an object within a field of view of the one or more image sensors;
capturing, via the one or more non-image sensors, sensor data including a sensed interaction with the object and a user of the wearable device; and
identifying a grasp action performed by the user based on a combination of the sensor data and the image data.

2. The wearable device of claim 1, wherein identifying the grasp action comprises determining an image-based grasp label by applying a frame-based model to the image data.

3. The wearable device of claim 2, wherein identifying the grasp action comprises determining a sensor-based grasp label by applying an event-based model to the sensor data.

4. The wearable device of claim 3, wherein identifying the grasp action comprises formatting the sensor-based grasp label to a formatted sensor-based grasp label, wherein the formatted sensor-based grasp label has a same format as the image-based grasp label.

5. The wearable device of claim 4, wherein formatting the sensor-based grasp label comprises at least one of:
applying a band pass filter to the sensor-based grasp label; and
performing a full-wave rectification.

6. The wearable device of claim 4, wherein identifying the grasp action comprises determining, using a grasp detection model, that the grasp action has occurred based on a combination of the image-based grasp label and the formatted sensor-based grasp label.

7. The wearable device of claim 1, wherein the memory further comprises instructions to perform operations for classifying the grasp action.

8. The wearable device of claim 7, wherein the grasp action is classified as one of a pinch, a palmar, or cylindrical grasp.

9. The wearable device of claim 1, wherein the memory further comprises instructions to perform operations for:
in accordance with identifying the grasp action, generating a signal configured to activate another device to perform an additional grasp event determination.

10. The wearable device of claim 1, wherein the memory further comprises instructions to perform operations for:
prior to identifying the grasp action, generating a combined frame by combining multiple frames of the plurality of frames, wherein the grasp action is based on analysis of the combined frame.

11. The wearable device of claim 10, wherein:
capturing the image data comprises:
capturing a first frame while an infrared (IR) emitter is inactive;
after capturing the first frame, capturing a second frame while the IR emitter is active; and
after capturing the second frame, capturing a third frame while the IR emitter is inactive; and
the combined frame is generated from the first frame, the second frame, and the third frame.

12. The wearable device of claim 11, wherein generating the combined frame comprises:
generating a fourth frame by averaging the first frame and the third frame; and
generating the combined frame by subtracting the fourth frame from the second frame.

13. The wearable device of claim 10, wherein the combined frame has a resolution of 30 pixels by 30 pixels or less.

14. The wearable device of claim 1, wherein the wearable device comprises a wrist-wearable device.

15. The wearable device of claim 14, wherein the one or more image sensors are coupled to at least one of: a capsule portion of the wrist-wearable device, and a band portion of the wrist- wearable device.

16. The wearable device of claim 15, wherein the one or more image sensors comprise one or more of:
a first image sensor coupled to a first portion of the band portion such that the first image sensor is adjacent to a thumb of the user while the wearable device is being worn by the user;
a second image sensor coupled to a second portion of the band portion such that the second image sensor is adjacent to a palm of the user while the wearable device is being worn by the user; and
a third image sensor coupled to a third portion of the band portion such that the third image sensor is adjacent to a pinky finger of the user while the wearable device is being worn by the user.

17. The wearable device of claim 1, wherein the one or more non-image sensors comprise neuromuscular sensors.

18. The wearable device of claim 1, wherein the sensor data comprises data corresponding to at least one of a movement of an arm of the user, vibration of an appendage of the user, and flexions of muscles of the user.

19. A non-transitory computer-readable storage medium storing one or more programs executable by one or more processors of a wearable device, the one or more programs comprising instructions for:
capturing, via one or more image sensors of the wearable device, image data including a plurality of frames, wherein the plurality of frames includes an object within a field of view of the one or more image sensors;
capturing, via one or more non-image sensors of the wearable device, sensor data including a sensed interaction with the object and a user of the wearable device; and
identifying a grasp action performed by the user based on a combination of the sensor data and the image data.

20. A method, comprising:
capturing, via one or more image sensors of a wearable device, image data including a plurality of frames, wherein the plurality of frames includes an object within a field of view of the one or more image sensors;
capturing, via one or more non-image sensors of the wearable device, sensor data including a sensed interaction with the object and a user of the wearable device; and
identifying a grasp action performed by the user based on a combination of the sensor data and the image data.
